(19) United States
(12) Patent Application Publication
(10) Pub. No.: US 2002/0175565 A1
(43) Pub. Date: Nov. 28, 2002

(54) Automotive anti-theft device

(76) Inventors: Larry Suber, Oxen Hill, MD (US); Debo Ogunrinde, Bowie, MD (US)

Correspondence Address: ALFRED F. HOYTE, 7734 16TH ST., N.W., WASHINGTON, DC, 20012, US

(21) Appl. No.: 09/861,877

(22) Filed: May 22, 2001

(51) Int. Cl. B60R 25/04

(52) U.S. Cl. 307/10.2

(57) ABSTRACT

An automotive security system features a carjacking prevention mode. In addition to performing typical security functions of an automotive alarm, the system allows the user to initiate the system on a delayed basis by manipulating a hidden floor switch or a remote paging device. When the system is activated, it begins flashing the light and activating the horns on an intermittent basis prior to disabling the vehicle, thereby giving the carjacker time to safely pull over. An audible verbal warning may alert the driver the vehicle is about to be disabled.

### BACKGROUND OF THE INVENTION

Approximately one of every 119 registered vehicles wound up as stolen property in the early 1990s. It has been stated that if auto-theft was a legitimate business, it would rank as one of the 50 most lucrative money making business in the Fortune 500 companies (Motor Trend™ 1991). Since the time Motor Trend™ made this statement, auto theft has risen dramatically. This increase is due to a new type of auto theft called car jacking. Since conventional design choices of the art such as sirens and audible alarms have lost their effectiveness because of false alarms, it is evident that any serious antitheft device must do much more than just make noise.

The present invention is directed to an automobile anti-theft device, and more particularly a device for preventing car jacking. Carjacking forces the legitimate owner of a vehicle to exit the car while the thief jumps in the car and drives off. In such cases, ordinary theft prevention devices are not very useful since they must be initiated when the legitimate driver is operating the vehicle. There are known anti-theft devices that would permit an owner/operator to immediately disable a vehicle at the first appearance of a carjacker. However, disabling the vehicle at that time presents significant danger to the vehicle occupant, who would be isolated alone with the carjacker.

U.S. Pat. No. 5,360,997 issued to Watson, discloses an anti-theft device which addresses a car jacking situation. Activation of either of two hidden switches by the owner will activate a timer, after time out of the timer you get auto failure. Circuit components allow ignition deactivation delay long enough to allow owner/occupant an unimpeded retreat to safety before auto shut down. The present invention offers increased safety and less complication in initiation of an anti-theft auto disablement device. Operation of the switching device is more discreet than prior art methods such as Watson.

### SUMMARY OF THE PRESENT INVENTION

One objective of the present invention is to provide maximum protection against theft of a stored vehicle, whether storage is temporary or permanent.

Another objective of the invention is to provide an anti-theft device which can be activated by the owner or authorized occupant upon exiting the vehicle, without detection by a carjacker.

Still another objective of the present invention is to provide such a device which does not inconvenience an authorized occupant during normal operation.

These and other objectives of the present invention are realized by an anti-theft device including a time delay circuit causing a theft prevention action, either by disablement of the vehicle, or disablement in conjunction with conventional alarms after a predetermined time. These actions are possible through a foot operated switch, that operates the time delay circuit when pressed a single time. The foot operated switch will be located on the floor of the vehicle to the left of gas and break pedals, where the high beam switch is located on older vehicles. This is a position not normally touched on entry or exit of a vehicle, so it can be pressed in an inconspicious manner.

A feature of the present invention is that one application of foot pressure activates the timing circuit, also one application of pressure for activation of a time delay circuit is new, and in contrast to the arrangement in U.S. Pat. No. 5,360,997 issued to Watson, which requires continued pressure on a floor mat switch. Continued pressure on the floor mat switch keeps the time delay circuit from operating. However, this causes the operator of the vehicle to drive in an awkward, uncomfortable and even a compromising position. The present invention enhances relaxation and covert applications for eminent auto disablement by eliminating a cramped body posture, and by eliminating exposure situations better than any system available today. The addition of the paging system offers the owner/occupant an extra opportunity to engage auto-disablement in case the floor switch was not applied. If the owner/occupant needs, or wants the security of letting the thief drive away before taking action, then he or she still has the option to telephone the paging system, and start auto shutdown, without fear of retaliation.

### BRIEF DESCRIPTION OF DRAWINGS

FIG. 1 is a perspective view detailing the location of the foot operated switch.

FIG. 2 shows a schematic of the circuitry of the system.

### DETAILED DESCRIPTION OF PREFERRED EMBODIMENT

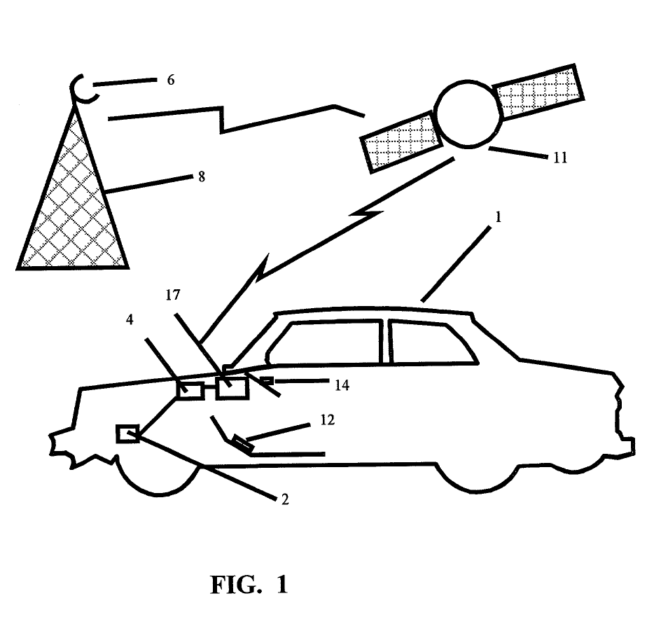

Referring now to FIG. 1, there is shown a diagram illustrating the overall anti-theft system of the present invention. A vehicle 1 is illustrated, which vehicle 1 has associated therewith a fuel valve 2. The fuel valve 2 is operable to interrupt the flow of fuel to the vehicle 1. This interruption can either be a total interruption or it can be an intermittent interruption. Further, the fuel valve 2 can be envisioned to be a variable or restricted flow valve.

The fuel valve 2 is controlled by a control system which includes a microprocessor which receives commands via a paging receiver 4. The paging receiver 4 is interfaced with a paging transmitter 6 disposed on the paging tower 8 which is often referred to as a “stick.” The paging tower 8 has associated therewith a satellite receiver 9 which is operable to interface with a satellite 11. In general, the paging system is a conventional paging system which is operable to receive paging messages in a conventional manner. One technique for transmitting these messages is referred to as a POCSAG format which generally involves the transmission of small packets of address and messages which are each comprised of an address portion and a data portion. The address portion of the message defines the actual address of the pager 4 with the following data being received by the pager 4 when it recognizes an address. Of course, all pagers in a system that have a receiver tuned to the paging frequency will receive all messages. Only the messages that are addressed to that pager will actually be captured and stored by the pager. Again, this is a conventional operation to receive digital information from a paging system.

The present invention is a microprocessor based antitheft system. A microprocessor based controller unit 17 coordinates all physically initiated applications of the system. A foot operated delay switch 12 may be used to initiate the alarm sequence. The system also allows for the paging transmitter to activate the system, so that the user may activate the system from a safe distance. A micro controller is ideal for use in an auto security system, it allows elimination of excessive circuitry and LEDs as well as unneeded switches that perform needed actions for auto disablement.

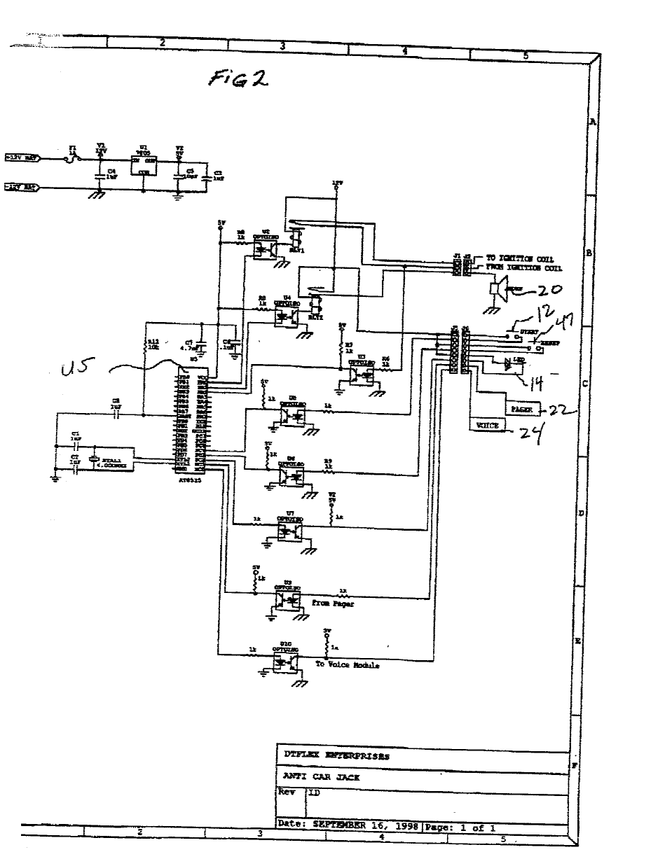

Referring now to FIG. 2, the invention and associated circuitry is shown. The switch 12 is located left of the gas and brake pedals on the slightly raised portion of the floor board, where the high beam switch in older autos was located. FIG. 1 also displays a possible location for an LED multipurpose light 14, which should be strategically placed for optimum view by carjackers and thieves, as well as the owner. In the preferred embodiment of the present invention operating the foot switch 12, or paging the vehicle, starts a delay time set to allow a carjacker to drive away in the vehicle, but not very far. For example, a time delay of three to six minutes will ensure that the carjacker has sufficient time to enter the vehicle and drive away before the vehicle is disabled. After the carjacker drives away, midway in the time out sequence a vocal implementation will tell the carjacker of eminent auto disablement and the amount of time before auto shut down occurs. There will also be flashing of head lamps, interior lights and dash board lights, accompanied by intermittent blowing of the horn while the auto is still moving. This is in contrast to conventional alarms that initiate these actions when the auto stops. These actions will increase the urgency of stopping the vehicle safely for all involved, the carjacker, the surrounding properties, pedestrians, and other motorists. At the end of the time out sequence, the preferred embodiment will cause disablement of the ignition system, interrupt the fuel pump circuitry and the like, thus demobilizing the automobile until reset is initiated by reset switch.

The use of the pre-programmed micro controller U5 offers a condensed and easy operational package. The controller U5 circuitry interfaces to the automobile wiring harness (not shown) at terminals J1 and J5. The J1 harness controlling voltage to the ignition (not shown), from the ignition, and to the horn 20. The wiring harness of J5 is connected to timing circuitry to start the time out for disablement, the reset switch, the active LED 26, the pager module 22, and the voice module 24. J I plugs into the vehicle 1 electrical system via J2 and J5 into J6 completing circuitry from controller US. U5 is a modular component that can be unplugged from the auto for maintenance purposes or for replacing certain parts. The LED multi functional light 26 is also replaceable. The non-volatile memory of the system is constantly intact even if power from the battery is disrupted. If power is disrupted to the system for whatever reason, the micro controller (U5) remembers through non-volatile memory to reinitialize the system to the last step before loss of power. For example, if power was disrupted while the system was in a state of auto disablement, upon re-energization, the hidden reset switch 47 must be activated before the system allows normal car operation. As soon as battery power is supplied to the unit, the micro-controller U5 sets up and normal checks are completed in less than ½ of a second.

Activation of the present invention for a stored vehicle is accomplished when the owner occupant turns the key off and depresses the foot switch 12 before leaving the vehicle locked and secured. When these steps are performed the system is automatically armed and regimented in an auto anti-theft profile.

If the auto anti-theft profile is disturbed by opening of a door, initiation of interior lights, utilization of the key ignition, etc., without first resetting the switch 12 using reset switch 47 the present invention will automatically disable the automobile by ignition interruption, fuel pump deactivation or the like. Of course the reset switch 47, may be replaced with a keypad for entering a code or combination as is well known in the art.

The non-volatile memory of the micro controller US will also initiate a periodic intermittent blowing of the horn and flashing of lights until the reset switch 47 is activated. With the system of the present invention, there is only one LED 14 with a variety of functional purposes. When the auto is off, the LED 14 is configured to blink at a fast pace, giving a resemblance to conventional alarms of the art as a deterrent to theft. When the system is armed, by floor switch 12, for storage security day or night, the LED 14 blinks at a slow pace, this is accomplished by turning off the key and depressing the floor mounted switch 12.

When the car is started by an authorized occupant, the LED 14 is automatically configured to turn off.

Lastly, when a legitimate occupant of the automobile is being car jacked, and the system is activated either by the floor switch 12 or the paging system by telephone, the LED 14 is constantly illuminated.

By using one LED with several easily explainable functions the owner-occupant will always know the readiness of the system by referring to one source for activation or deactivation. In accordance with one aspect of the invention a user wearable pager may be configured to receive a signal from a paging transmitter mounted within the car, with the user wearable pager serving to indicate the status of the system. The paging transmitter would be configured to transmit the system status to the user wearable pager. The user wearable pager may be configured to display, in unison with LED 14, the system status. Thus, when the LED 14 is blinking, an LED on the user wearable pager will blink in unison. Of course the user wearable pager will emit an audible or vibrational signal if the vehicle 1 is cracked, coupled with the LED indication.

Referring again to FIG. 2, the system includes a pre programmed micro-controller (U5) as has been previously mentioned. When the system is properly installed in a car, e.g., with the unit 17 under the front seat or other inconspicuous location, LED 14 on the dash board, switches 12 and 47 installed in a hidden but easily accessible location, which location may be selected by the installer and should be varied with each installation, the unit performs as follows, as long as the car battery is operational. It can be noted that all the setup and normal checks are completed in less than ½ of one second.

1. After initial complete installation, controller U5 is programmed to perform self initialization and setup. This function is performed every time the unit is disconnected from the battery.

2. On completion of setup 1, controller U5 checks internal special EEPROM location to determine the previous status prior to power being removed. If previous status was alarm state, the controller U5 proceeds to step SC-2.1. Otherwise normal operation will continue.

3. In normal operation, controller U5 continuously checks inputs PA2-ignition, PC4-START, PC I PAGE module.

4. No input from step 3 means that the car ignition is OFF. The LED will start to flash SLOWLY. Steps 3 and 4 are continuously repeated until U5 receives input from PA2-ignition, PC4-START, or PC I PAGE module. The following scenarios ensue depending upon which input sends a signal to the controller U5.

(Scenario 1.)—Input PA2 is received.

SC-I This entails that the ignition is on. The LED is extinguished. Return to step 3.

(Scenario 2.)—While input PA2 (Ignition) is ON, input PC4 (START) is received.

SC-2.1 U5 assumes that this a potential carjack situation, LED is on and not blinking, U5 set a timer for 5 minutes and then continues to monitor inputs in addition to PC3 (RESET).

SC-2.2 If PC3 is received at any time prior to the end of 5 minutes or beginning of audible alarm (HORN), the timer is reset and the LED is off.

SC2.3 At the end of 5 minutes, U5 activates voice module to give a warning THIS CAR WILL TURN ITSELF OFF AT THE END OF I MINUTE PLEASE STOP THE CAR NOW IN A SAFE MANNER. (or similar verbiage)

SC-2.4 At the end of 1 minute, U5 activates RL1 to shut off the ignition, RL2 is activated to turn on the HORN (for 3 minutes) and optionally flash the headlights and taillights, also a signal is sent to the internal EEPROM to indicate alarm status.

SC-2.5 The unit will remain in this state until input PC3 (RESET) is received.

Scenario 3—While input PA2 (IGNITION) is ON input PAI (PAGE module) is received(SC-3). The unit reacts the same as in Scenario 2 above.

Scenario 4—While input PA2 (IGNITION) IS OFF, input PC4 (START) or input PC I (PAGE) is received.

SC-4.1 U5 activates LED to flash fast.

SC-4.2 U5 activates RL I to preclude the ignition start.

SC-4.3 U5 monitors input PC3 for RESET which is triggered by the reset switch as has been previously explained. The RESET signal must be received by U5 before the car 1 can start.

Thus, in the event of a carjacking the system can be activated either by footswitch 12 or by telephone via the paging system. Once activated, the system will time out in 3 to 6 minutes, allowing sufficient time for the owner of the vehicle to get to a safe distance.

Since numerous modifications and variations will readily occur to those skilled in the art, it is not desired that the present invention be limited to the exact construction and operation illustrated and described herein, and accordingly all suitable modifications and equivalents which may be resorted to are intended to fall within the true spirit and scope of the claimed invention.

What is claimed is:

1. An alarm system for an automobile comprising:
a controller, said controller connected to an ignition system, a horn, and an automotive lighting system;
a signal input means connected to said controller for inputting an activation signal to said controller, said activation signal generated either by manipulation of a switch in said automobile or a pager receiving system connected to said controller;
whereby receipt of said activation signal causes said controller to deactivate said ignition system, and activate said horn and lighting system intermittently after a predetermined delay.

2. The system of claim 1 including means for activating said horn and lighting system a predetermined amount of time before deactivation of said ignition system.

3. The system of claim 1 wherein a single LED indicates the operative state of the system.

4. The system of claim 4 wherein said single LED is constantly illuminated when the activation signal has been received, blinks at a first speed when the system is armed and the automobile engine is running, blinks at a second speed when the system is armed and the automobile is not running, and is off when the automobile is running and the system is not armed.

5. The system of claim 4 wherein said system includes a paging transmitter mounted on said automobile, said paging transmitter transmitting a signal to a portable, user wearable, paging receiver having an LED indicator, wherein said paging transmitter signal causes said paging receiver LED indicator to be activated in unison with said single LED.
